(19) United States
(12) Patent Application Publication
(10) Pub. No.: US 2013/0247697 A1
(43) Pub. Date: Sep. 26, 2013

(54) RACK-AND-PINION STEERING SYSTEM HAVING A SIMPLE SEALING

(71) Applicants: Joachim Bahr, Plochingen (DE); Edwin Breuning, Denkendorf (DE); Paul Heinzen, Laubach (DE); Kai Vohwinkel, Reichenbach (DE)

(72) Inventors: Joachim Bahr, Plochingen (DE); Edwin Breuning, Denkendorf (DE); Paul Heinzen, Laubach (DE); Kai Vohwinkel, Reichenbach (DE)

(73) Assignee: ThyssenKrupp Presta AG, Eschen (LI)

(21) Appl. No.: 13/990,527

(22) PCT Filed: Dec. 7, 2011
(86) PCT No.: PCT/EP2011/006149

§ 371 Date: May 30, 2013

(30) Foreign Application Priority Data
Dec. 8, 2010 (DE) 10 2010 053 770.5

(51) Int. Cl. B62D 3/12

(52) U.S. Cl. CPC B62D 3/12
USPC 74/30

(57) ABSTRACT

The invention relates to a rack and pinion steering system for a motor vehicle, comprising a steering box (2) in which a rack is displaceably mounted, and a thrust piece bore (1) accommodating a thrust piece which is forced against the rack by means of a set screw (11) screwed into a thread zone (6, 7). The invention is characterised in that a groove (8) is cut in the thread zone (6, 7) of the thrust piece bore radially outwards and a sealing ring (16) is inserted in said groove (8).

The invention relates to a rack and pinion steering system for motor vehicles having the features of the preamble of claim 1.

Rack and pinion steering systems in which a pinion actuated via a steering wheel and a steering shaft meshes with a tooth segment of a linearly moveable rack for adjusting the steering angle of steered wheels of a motor vehicle, have been known for a long time, from US Patent, U.S. Pat. No. 326,244, for example. The pinion and rack should be in engagement without clearance during operation.

In motor vehicles, the engagement without clearance is generally produced via a thrust piece which forces the rack against the piston from the side opposite the pinion. The thrust piece is preloaded by means of a spring and can produce a certain stroke between 0.01 and 0.6 millimetres against the pressure of the spring. The preload and the stroke are adjusted via a set screw which is axially displaceable by means of a screw thread in the steering box. This is known, for example, from US patent application US 2003/0188918 A1. The set screw is secured in the selected adjustment position by means of a lock nut.

A further requirement consists in the sealing of the steering box relative to the environment in the region of the thrust piece. Said sealing is generally performed by an earring which is inserted in a groove of the thrust piece circulating on the peripheral side and sealed against the wall of the bore in the steering box. Such seals are known from US Patent, U.S. Pat. No. 5,272,933, and DE 102 30 602 A1. The first document also discloses an adjustment of the thrust piece by means of a set screw which is secured by a lock nut. The second document discloses a thrust piece arrangement for preloading a roller bearing wherein the thrust piece is sealed by means of an earring in a bore in the housing and a cover having a second earring is also inserted into said bore opposite the housing above the thrust piece in a sealing manner. The cover is not attached via a screw thread, but by fixing the housing into place.

Finally, a thrust piece arrangement is known from EP 1 291 261 A2 wherein the thrust piece is preloaded against the rack via a helical spring and a cover, said cover being in contact with a bundled coil of the housing via a circulating earring thereby creating a seal. The cover is secured in the steering box by means of a retaining ring and thus cannot be adjusted.

The design of the seal in the region of the thrust piece and the protection of the adjusting screw against unintentional turning are design features which are provided in prior art at relatively high cost. A large number of production steps, component parts and assembly steps is required.

It is therefore the task of the present invention to provide a rack and pinion steering system wherein the manufacture and assembly in the region of the adjustable thrust piece are simplified. As a result, the rack and pinion steering system should be quicker and less expensive to produce.

This object is solved by a rack and pinion steering system having the features of claim 1.

Since a groove cut radially outwards in the thread zone of the thrust piece bore is provided and since a sealing ring, preferably made of a thermoplastic material, is inserted into said groove, the set screw can slot into the ring in said thread zone during assembly and thereby both sealing and protection of the set screw against unintentional loosening can be achieved. A particularly simple construction is possible as a result of the set screw being manufactured as a deep drawn component.

In a further, particularly advantageous configuration of the invention, the groove can be inserted using a non-cutting method and the structure inserted into the housing using an embossing method.

The ring enclosed in the groove is preferably made from PFTE.

When the set screw is screwed in, the thread of the screw slots into the PTFE ring. This leads to a meshing effect on the screw.

At the same time, a sealing effect is created by the cutting, since the flank clearance of the screw thread is reduced and the PDFE creates a sealing layer between the flanks.

It is also advantageous to provide a structure in the cylindrical outer region of the groove which prevents the turning of the ring at the same time as screwing in the set screw.

An embodiment of the present invention is described in greater detail below on the basis of the drawings.

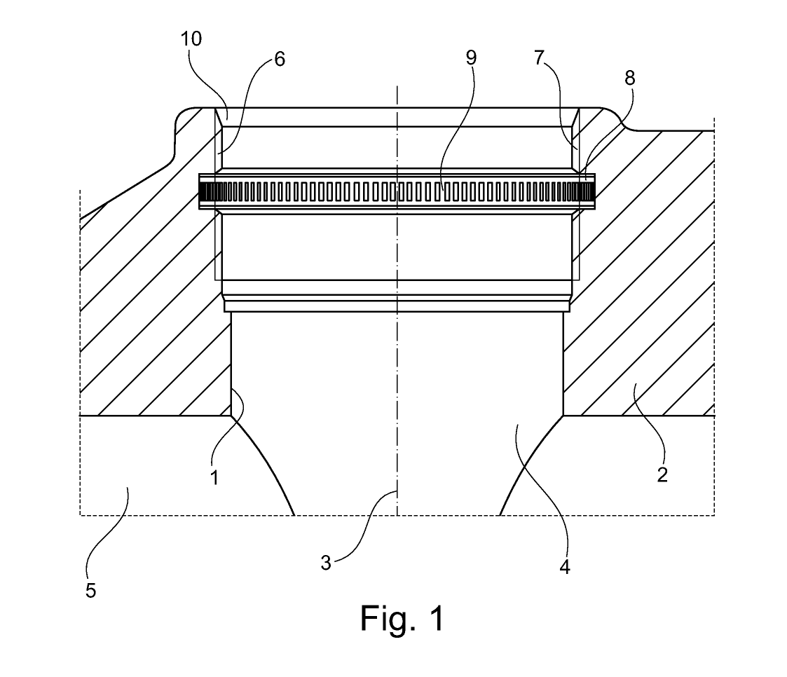

FIG. 1 shows a longitudinal section of the thrust piece bore of a steering gear;

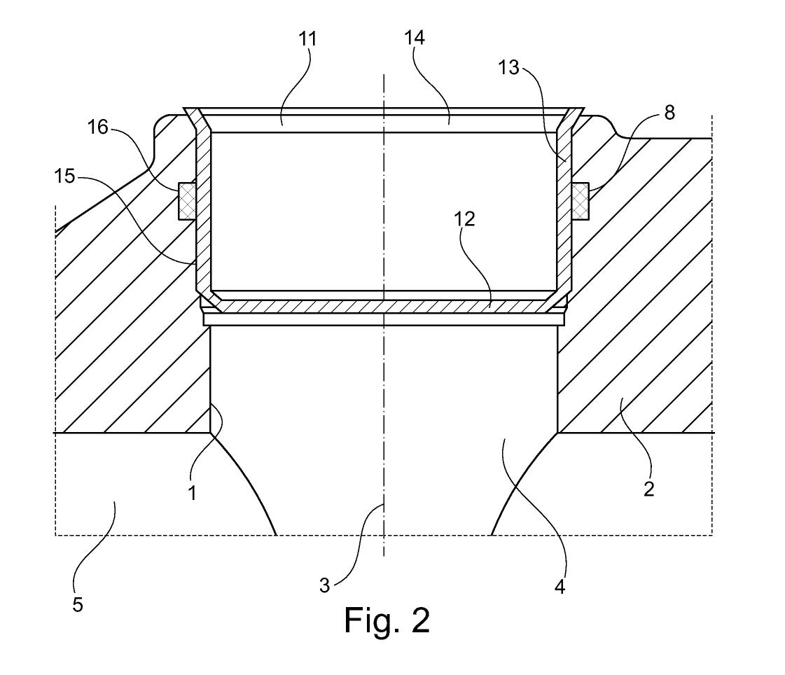

FIG. 2 shows the region from FIG. 1 with set screw inserted; and

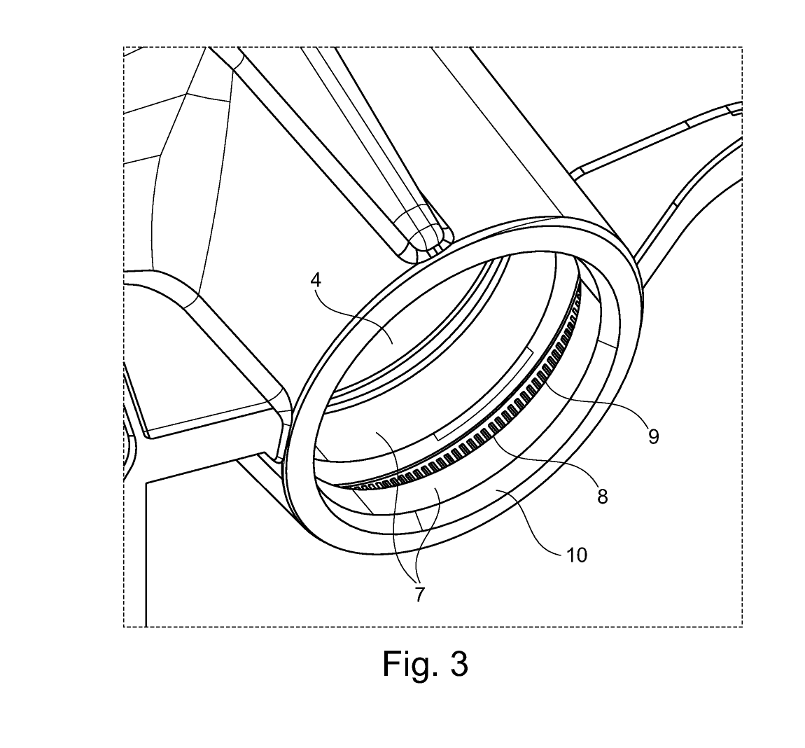

FIG. 3 shows a perspective representation of the region of the thrust piece from FIG. 1.

FIG. 1 shows an enlarged longitudinal section of the region of a thrust piece bore 1 in a steering gear box 2.

The steering gear box 2 has a thrust piece bore 1 here which is configured substantially rotationally symmetrically in the direction of an axis 3. The thrust piece bore 1 has a cylindrical outer surface 4 which serves as a guide for a thrust piece not shown here. A through bore runs through the steering gear box 2 perpendicular to the axis 3, in FIG. 1 horizontally, in which the rack is mounted in an axially displaceable manner during operation. The pinion is arranged opposite the thrust piece bore 1 relative to the rack. This region has not been shown in the interests of greater clearness.

A region with an enlarged diameter 6 is provided in an axial direction of axis 3 adjacent to the thrust piece 1 and said region is provided with an inner thread 7. A groove 8 cut radially outwards relative to the axis 3 is in turn provided in the inner thread where said groove 8 has a substantially square cross section. The groove 8 also has a knurl 9 on its outer peripheral surface which constitutes the base of the groove. In addition, the closure to the outer side of the steering box 2 is extended conically in an axial direction 3 and forms a conical surface 10.

FIG. 2 shows the longitudinal section of the steering box 2 from FIG. 1 wherein a set screw 11 is inserted into the bore 6. The set screw 11 has a cup-shaped base body with a closed, plate-shaped bottom 12 as well as a cylindrical wall 13 which extends conically upwards to the open end of the base body into a region 14. The set screw 11 is provided with an outer thread 15 on the outside which is compatible with the inner thread 7. A sealing and securing ring 16 is inserted into the groove 8. Alternatively, a bore not shown here can be provided on the set screw 11 coaxially to the axis 3, where said bore is sealed with a plug which is not shown either.

The sealing and securing ring 16 is made of a thermoplastic and/or an elastomer material, preferably PTFE. It has an inner diameter which, when fitted into the groove 8, extends into the region of the thread 7 or preferably in a radial direction of the axis 3 over the thread 7 into the inner region of the bore 6.

The set screw 11 is preferably made from sheet steel using the deep drawing method. It can be easily provided with an outer thread which can be rolled or cut. A tooth contour or a similar drive for a tool can be provided further inside the set screw 11.

When fitting the power-assisted steering, firstly the rack is introduced into the cross bore 5 in a known manner. A thrust piece is then inserted into the bore 1 in the direction of the axis 3 until it rests on the rack. A spring means, for example, a helical spring, is positioned as a pressure spring on the side of the thrust piece facing away from the rack. The ring 16 is inserted into the groove 8. The set screw 11 is then screwed into the bore 6, more specifically into the thread 7, until the required clearance of 0.1 millimetres, for example, is achieved between the bottom 12 and the thrust piece. When screwing into the thread 7, the outer thread 15 of the set screw 11 slots into the radially inward facing surface of the sealing and securing ring 16. A sealing of this region is hereby achieved which is both dust proof and waterproof. Also, if appropriate material is selected, the set screw 11 is secured so well in the ring 16 thereby ruling out an unintentional adjustment of the set screw 11. It is obvious that the design described so far is considerably easier to produce and fit compared with the prior art explained at the beginning. This increases process reliability during manufacture. In particular, the possibility of producing the set screw 11 using the deep drawing method, simplifies the production of this element. Lock nuts or other securing means can be dispensed with. The production of a groove for an earring in the thrust piece to be used can also be dispensed with.

Finally, FIG. 3 shows a perspective representation of the region shown in cross section in FIGS. 1 and 2. The same elements are provided with the same reference signs. The knurl 9 of the groove 8 secures the ring 16 inserted into the groove 8 against turning. Said knurl 9 thus contributes towards the securing of the set screw 11 in the position thereof.

1. A rack and pinion steering system for a motor vehicle, comprising:
a steering box having a rack that is displaceably mounted, and a thrust piece bore accommodating a thrust piece that is forced against the rack by means of a set screw screwed into a thread zone of the thrust piece bore,
wherein the thread zone of the thrust piece bore has a groove cut radially outwards, and wherein a sealing ring is inserted in said groove.

2. The rack and pinion drive according to claim 1, wherein the set screw is produced as a deep drawn component.

3. The rack and pinion drive according to claim 1, wherein the sealing ring is made of a thermoplastic material.

4. The rack and pinion drive according to claim 1, wherein the sealing ring is made of an elastomer material.

5. The rack and pinion drive according to claim 1, wherein the sealing ring is made of PTFE.

6. The rack and pinion drive according to claim 1, wherein the groove is provided with a structure in its cylindrical outer region.

7. The rack and pinion drive according to claim 1, wherein the sealing ring extends radially relative to an axis into the region of an inner thread.

8. The rack and pinion drive according to claim 1, wherein the set screw is provided with a drive structure.

9. The rack and pinion drive according to claim 1, wherein the groove (8) is produced using a non-cutting method.

10. The rack and pinion drive according to claim 1, wherein the groove has a knurl that is produced in the base of the groove using an embossing method.

11. The rack and pinion drive according to claim 10, wherein the knurl in the base of the groove is taken into account in a casting mold.
